(19) United States
(12) Patent Application Publication
(10) Pub. No.: US 2026/0142105 A1
(43) Pub. Date: May 21, 2026

(54) BUTTON MOTOR AND ELECTRONIC DEVICE

(71) Applicant: AAC Microtech (Changzhou) Co., Ltd., Changzhou City (CN)

(72) Inventors: Lubin Mao, Changzhou (CN); Wei Song, Changzhou (CN)

(21) Appl. No.: 19/169,031

(22) Filed: Apr. 3, 2025

Related U.S. Application Data
(63) Continuation of application No. PCT/CN2024/133466, filed on Nov. 21, 2024.

(51) Int. Cl. H01H 36/00; H01H 15/00; H01H 15/04; H01H 15/10; H01H 15/22

(52) U.S. Cl. CPC H01H 36/0073; H01H 15/005; H01H 15/04; H01H 15/10; H01H 15/22

(57) ABSTRACT

The present disclosure provides a button motor and an electronic device. The button motor includes: a hollow housing; a stator fixed at both ends of the housing; a vibrator having two ends elastically supported on the both ends of the housing, respectively; and a button device fixed to the vibrator. The vibrator includes a magnet and pole cores fixed on both sides of the magnet, respectively. The stator includes two iron cores respectively fixed on both sides of the housing and coils respectively wound on the two iron cores. The button motor further includes two non-metallic elastic components respectively fixed at the both ends of the housing, and the two non-metallic elastic components are fixedly connected to the vibrator, respectively.

### CROSS REFERENCE TO RELATED APPLICATIONS

The present application is a continuation of PCT Patent Application No. PCT/CN2024/133466, filed Nov. 21, 2024, which is incorporated by reference herein in its entirety.

### TECHNICAL FIELD

The present disclosure relates to the field of button technology, and in particular to a button motor and an electronic device.

### BACKGROUND

The touchable buttons are a type of buttons configured to achieves touch control by sensing pressing signals. Specifically, accurate detections are achieved by sensing the pressing positions and pressing forces, thereby achieving precise control.

A touchable button mainly includes a housing, a motor fixed inside the housing, and buttons fixed to the motor. The motor is mainly composed of a stator and a vibrator, and the vibrator is elastically supported on the housing and spaced apart from the stator. The working principle of the touchable button is that when the button is subjected to pressing force, displacement of the vibrator occurs in the pressing direction, and corresponding control can be achieved by detecting the amount of the displacement and the position in which the displacement occurs.

In the related technologies, vibrators are all elastically supported on the housing by metal elastic components. Although this design increases the structural strength of the elastic components, the space occupied by the elastic components also increases due to the metal characteristics of the elastic components, which leads to a decrease in the dimensions of magnetic circuits of the touchable buttons with structures having the same dimensions, thereby resulting in insufficient drive force.

Therefore, it is necessary to provide a button motor to address the above-mentioned problem.

### SUMMARY

The present disclosure aims to provide a button motor and an electronic device, in order to address the problem in related technologies that vibrators are elastically supported on the housing by metal elastic components, leading to increasing in the space occupied by the elastic components.

In first aspect, the present disclosure provides a button motor including: a hollow housing; a stator fixed at both ends of the housing; a vibrator having two ends elastically supported on the both ends of the housing, respectively; and a button device fixed to the vibrator. The vibrator is spaced apart from the stator and is moveable in a first direction relative to the stator. The vibrator includes a magnet and pole cores fixed on both sides of the magnet in the first direction, respectively, and the button device is fixed on a side of one pole core of the pole cores away from the magnet. The stator includes two iron cores respectively fixed on both sides of the housing and coils respectively wound on the two iron cores. The button motor further includes two non-metallic elastic components fixed at the both ends of the housing, respectively, and the two non-metallic elastic components are deformable in the first direction. The two non-metallic elastic components are fixedly connected to the vibrator, respectively, and are configured to elastically suspend the vibrator inside the housing.

As an improvement, the button motor further includes connectors integrally formed with the two non-metallic elastic components, respectively. Each connector of the connectors is formed on a side of a respective non-metallic elastic component of the two non-metallic elastic components facing the vibrator and is fixedly connected to the vibrator.

As an improvement, the connectors are respectively fixed to the pole cores and spaced apart from the magnet.

As an improvement, a respective recess extending away from the magnet is defined on a surface of each non-metallic elastic component of the two non-metallic elastic components facing the magnet, and the connectors are formed in recesses, respectively.

As an improvement, the two non-metallic elastic components are integrally formed with the vibrator.

As an improvement, the two non-metallic elastic components are made of silicone or rubber.

As an improvement, each non-metallic elastic component of the two non-metallic elastic components has a respective fixing portion extending from a respective outer periphery of each non-metallic elastic component, fixing holes passing through the housing are defined on the housing, and each fixing hole of the fixing holes is configured for the respective fixing portion to extend through.

As an improvement, the housing includes two lateral casings opposite to each other and parallel to a long-axis direction of the housing, a first end cap, and a second end cap, and each of the first end cap and the second end cap is connected to the two lateral casings at respective ends of the two lateral casings. The two iron cores are respectively fixed on sides of the two lateral casings facing each other, and the two non-metallic elastic components are respectively fixed to the first end cap and the second end cap.

As an improvement, the two lateral casings are both in a form of flat plates; or the two lateral casings are both magnetic conductive structures and each have a U shape.

As an improvement, the button device includes a main body spaced apart from and opposite to the housing and a first connection portion and a second connection portion extending from a surface of the main body facing the pole cores, and each of the first connection portion and the second connection portion extends into the housing and is fixed to a pole core.

In second aspect, the present disclosure provides an electronic device including the button motor as illustrated above and a frame configured to accommodate the button motor. A recessed accommodating slot is defined on an outer surface of the frame, and through holes are defined on a bottom of the accommodating slot. The housing is fixed to an inner surface of the frame opposite to the outer surface, and a portion of structures of the button device is accommodated in the accommodating slot, passes through the through holes, and is fixed to the vibrator.

Compared with the related technologies, in the button motor according to the present disclosure, two non-metallic elastic components respectively fixed at the both ends of the housing are provided, the two non-metallic elastic components are deformable in the first direction, and are configured to elastically suspend the vibrator inside the housing. In this way, the space occupied by the assembled elastic components can be reduced by using non-metallic elastic design, such that dimensions of magnetic circuits can be maximized with the dimension of the structure of the button motor being unchanged, thereby ensuring sufficient drive force of the button motor.

### BRIEF DESCRIPTION OF DRAWINGS

In order to illustrate the technical solutions in the embodiments of the present disclosure more clearly, the drawings to be used in the illustration of the embodiments will be briefly described below. It is obvious that the drawings mentioned in the following illustration are only some embodiments of the present disclosure. For those of ordinary skill in the art, other drawings may be obtained in accordance with these drawings without any inventive effort.

FIG. 1 is a schematic diagram of a three-dimensional structure of the button motor according to some embodiments of the present disclosure.

FIG. 2 is an exploded view of the structure of the button motor according to some embodiments of the present disclosure.

FIG. 3 is a schematic diagram of the structure of the button motor according to some embodiments of the present disclosure, with the button device being removed.

FIG. 4 is a cross-sectional view taken along the A-A line in FIG. 1.

FIG. 5 is a cross-sectional view taken along the B-B line in FIG. 1.

FIG. 6 a schematic diagram of a three-dimensional structure of the button motor according to some embodiments of the present disclosure, with the button device and the mounting portion being removed.

FIG. 7 is a cross-sectional view taken along the C-C line in FIG. 6.

FIG. 8 is a schematic diagram of a three-dimensional structure of the button motor according to some embodiments of the present disclosure, with the button device and the mounting portion being removed.

FIG. 9 is an exploded view of the structure of the button motor according to some embodiments of the present disclosure, with the button device and the mounting portion being removed.

FIG. 10 is a cross-sectional view taken along the D-D line in FIG. 8.

FIG. 11 is a schematic diagram of a three-dimensional structure of the electronic device according to some embodiments of the present disclosure.

FIG. 12 is an exploded view of the structure of the electronic device according to some embodiments of the present disclosure.

In the drawings:

100—button motor; 1—housing; 11. lateral casing; 12. first end cap; 13. second end cap; 14. fixing hole; 2. stator; 21. iron core; 22. coil; 3. vibrator; 31. magnet; 32. pole core; 4. button device; 41. main body; 42. first connection portion; 43. second connection portion; 44. guide component; 5. non-metallic elastic component; 51. recess; 52. fixing portion; 6. connector; 7. mounting portion; 71. mounting hole; 200. electronic device; 201. frame; 202. accommodating slot; 203. through hole.

### DETAILED DESCRIPTION OF EMBODIMENTS

The technical solutions in the embodiments of the present disclosure will be clearly and completely illustrated in conjunction with the accompanying drawings. Obviously, the illustrated embodiments are only a part of the embodiments of the present disclosure, not all of them. All other embodiments obtained by those skilled in the art based on the embodiments of the present disclosure without creative works fall within the scope of protection of the present disclosure.

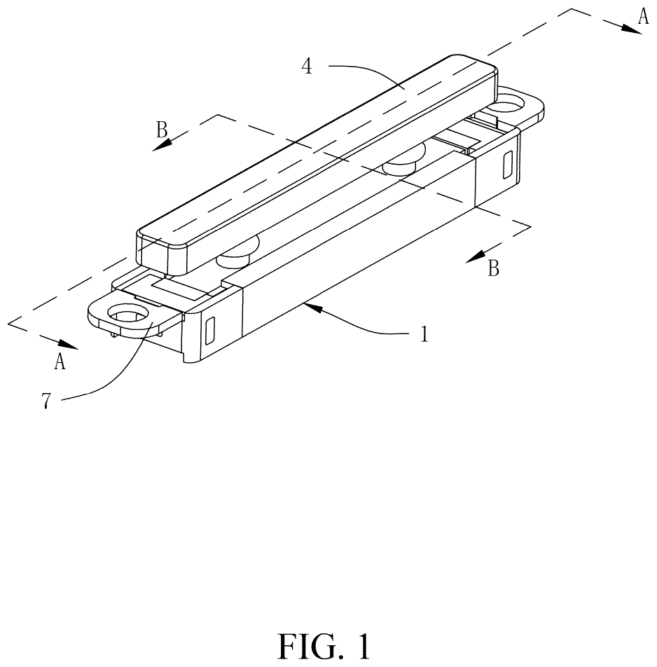

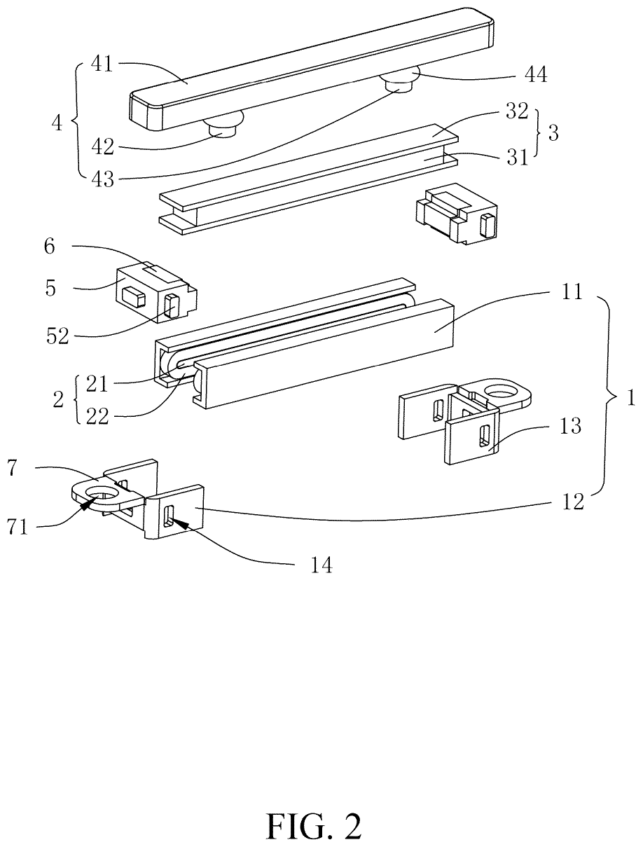

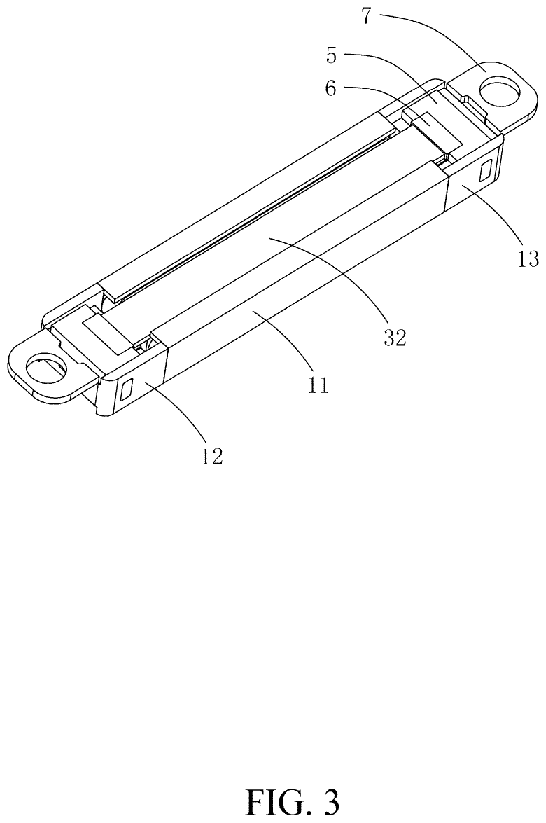

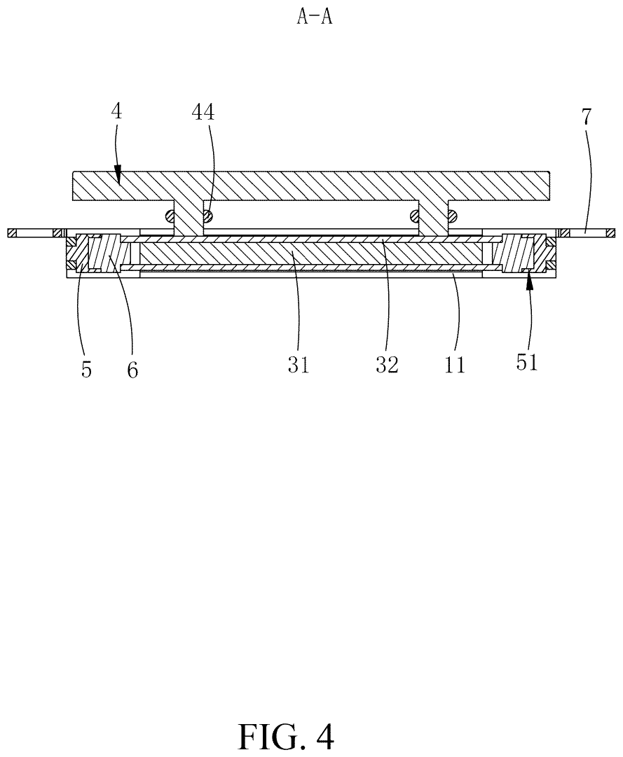

Some embodiments of the present disclosure provide a button motor 100, referring to FIGS. 1 to 5, the button motor includes a hollow housing 1, a stator 2 fixed at both ends of the housing 1, a vibrator 3 having two ends elastically supported on the both ends of the housing 1, respectively, and a button device 4 fixed to the vibrator 3. The vibrator 3 is spaced apart from the stator 2 and is moveable in a first direction relative to the stator 2. The vibrator 3 includes a magnet 31 and pole cores 32 fixed on both sides of the magnet 31 in the first direction, respectively, and the button device 4 is fixed on a side of one pole core 32 of the pole cores away from the magnet 31. The stator 2 includes two iron cores 21 respectively fixed on both sides of the housing 1 and coils 22 respectively wound on the two iron cores 21.

The first direction refers to the direction in which the vibrator 3 vibrates, that is, the direction of the displacement of the button device 4 when the button device 4 is pressed.

The housing 1 includes two lateral casings 11 opposite to each other and parallel to a long-axis direction of the housing, a first end cap 12, and a second end cap 13, and each of the first end cap 12 and the second end cap 13 is connected to the two lateral casings 11 at respective ends of the two lateral casings 11. The two iron cores 21 are respectively fixed on sides of the two lateral casings 11 facing each other.

Each of the first end cap 12 and the second end cap 13 has, on a side facing away from each other, a respective mounting portion 7, and the respective mounting portion 7 has a mounting hole 71 passing through the respective mounting portion. In this way, the button motor 100 can be mounted to other devices by screws or rivets through the mounting holes 71.

In some embodiments, the two lateral casings 11 are both magnetic conductive structures and each have a U shape. Each of the two iron cores 21 is fixed in a middle region of a respective lateral casing 11, and the two iron cores 21 are arranged opposite to each other. Each of the first end cap 12 and the second end cap 13 has a U shape.

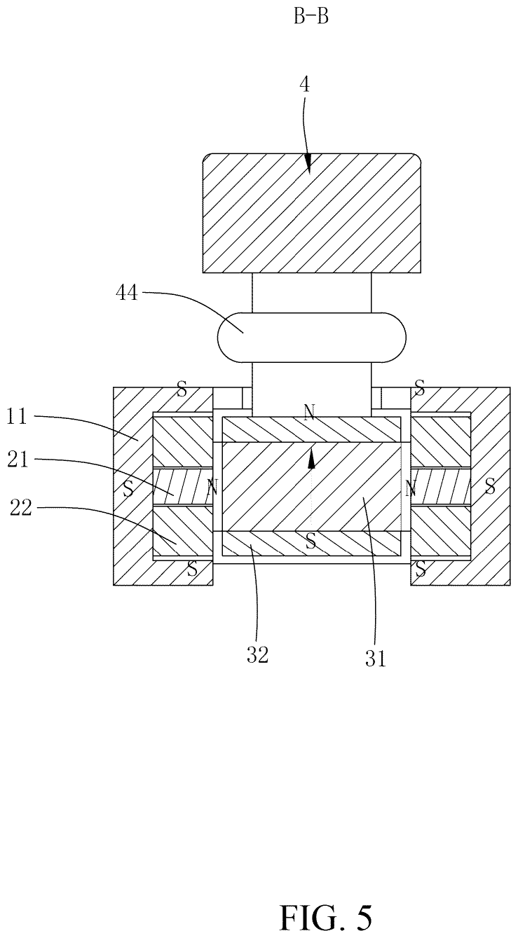

When the coils 22 are energized, the two lateral casings 11 and the two iron cores 21 are polarized to form different magnetic poles, as shown in FIG. 5. Correspondingly, the pole cores 32 vibrates under the forces from the two lateral casings 11 and the two iron cores 21.

The button device 4 includes a main body 41 spaced apart from and opposite to the housing 1 and a first connection portion 42 and a second connection portion 43 extending from a surface of the main body 41 facing the vibrator 3, and each of the first connection portion 42 and the second connection portion 43 extends into the housing 1 and is fixed to a pole core 32.

The button motor 100 further includes guide components 44 sleeved on the first connection portion 42 and the second connection portion 43, respectively. In this way, the guide components 44 can be mounted on the frame of the electronic device 200 to guide the first connection portion 42 and the second connection portion 43.

The button motor 100 further includes two non-metallic elastic components 5 respectively fixed at the both ends of the housing 1 and connectors 6 integrally formed with the two non-metallic elastic components 5, respectively. The two non-metallic elastic components 5 are deformable in the first direction. The connectors 6 are fixed to the other pole core 32 and are spaced apart from the magnet 31. The connectors 6 are configured to suspend the vibrator 3 inside the housing 1.

In some embodiments, the two non-metallic elastic components 5 are made of silicone or rubber, and the housing 1 and the connectors 6 made of metal materials, such as stainless steel, aluminum alloy, or the like. The two non-metallic elastic components 5 are integrally formed with the connectors 6 by injection molding. Each of the two non-metallic elastic components 5 and the connectors 6 has a block shape.

The two non-metallic elastic components 5 are respectively fixed to the first end cap 12 and the second end cap 13.

Each of the connectors 6 has a respective middle portion facing the magnet 31 and extending into the space between the two pole cores 32.

The magnet 31 is magnetized by magnetizing the two pole cores 32 on the both sides of the magnet 31 into different magnetic poles, namely N pole and S pole, as shown in FIG. 5.

Each non-metallic elastic component 5 has a respective fixing portion 52 extending from a respective outer periphery of each non-metallic elastic component. Fixing holes 14 passing through the housing 1 are defined on the housing 1, and each fixing hole 14 is configured for the respective fixing portion 52 to extend through.

In some embodiments, the fixing holes 14 are defined on the first end cap 12 and the second end cap 13 of the housing 1, respectively. Each fixing portion 52 is formed on surfaces of a respective non-metallic elastic component 5 except a surface facing the vibrator 3. Accordingly, the fixing holes 14 are respectively defined on the U-shaped first end cap 12 and the U-shaped second end cap 13 at the positions corresponding to the fixing portions 52.

A respective recess 51 extending away from the magnet 31 is defined on a surface of each non-metallic elastic component 5 facing the magnet 31, and the connectors 6 are formed in recesses 51, respectively. In this way, the space occupied by the non-metallic elastic component 5 and the connectors 6 can be further reduced.

Due to the difficulty of integrally forming the magnet 31 and the pole cores 32 of the vibrator 3 with the non-metallic elastic components 5 using injection molding, adding the connectors 6 can make it easier to integrally form the non-metallic elastic components 5 with the vibrator 3 using injection molding. Alternatively, the non-metallic elastic components 5 can be integrally formed with the vibrator 3 by injection molding, without adding the connectors 6, using base coating of silicone.

In some embodiments, a cross-section of each non-metallic elastic component 5 along the first direction has a C-like shape. In this way, deformation degree of each of the non-metallic elastic components 5 along the first direction during working of the button motor can be controlled in an appropriate range, thereby improving user experience of the button motor.

In some embodiments, each non-metallic elastic component of the two non-metallic elastic components 5 may be divided into two or more respective non-metallic elastic sub-components. In other words, each non-metallic elastic component 5 has a split-type design. Taking each non-metallic elastic component 5 being divided into two respective non-metallic elastic sub-components as an example, the two respective non-metallic elastic sub-components are arranged at a same end of the housing 1, and are separated from each other. In this way, the material for the non-metallic elastic components 5 can be saved, and the deformation degree of the non-metallic elastic components 5 along the first direction can be ensured.

In some embodiments, each connector 6 has an overall dimension smaller than an overall dimension of each non-metallic elastic component 5. In this way, the influence on the deformation of each non-metallic elastic component 5 along the first direction due to direct contact between each non-metallic elastic component 5 and a respective connector 6 can be reduced.

Depending on actual needs, the button motor 100 further includes a flexible circuit board (not shown) electrically connected to the coils 22 and a sensor (not shown) electrically connected to the flexible circuit board. The sensor is configured to detect the pressing position and the pressure degree on the button device 4. The flexible circuit board is configured to energize the coils 22 and issue corresponding control commands based on the detection results of the sensor.

Compared with the related technologies, in the button motor 100 according to the present disclosure, two non-metallic elastic components 5 respectively fixed at the both ends of the housing 1 are provided, the two non-metallic elastic components 5 are deformable in the first direction, and are configured to elastically suspend the vibrator 3 inside the housing 1. In this way, the space occupied by the assembled elastic components can be reduced by using non-metallic elastic design, such that dimensions of magnetic circuits can be maximized with the dimension of the structure of the button motor 100 being unchanged, thereby ensuring sufficient drive force of the button motor.

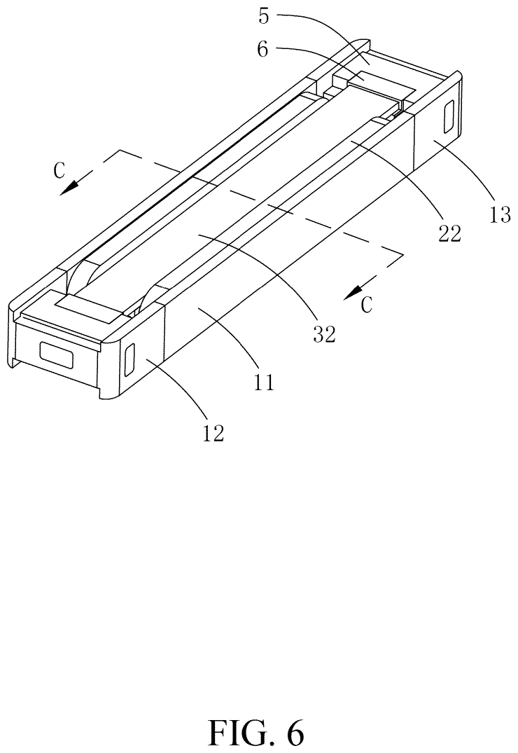

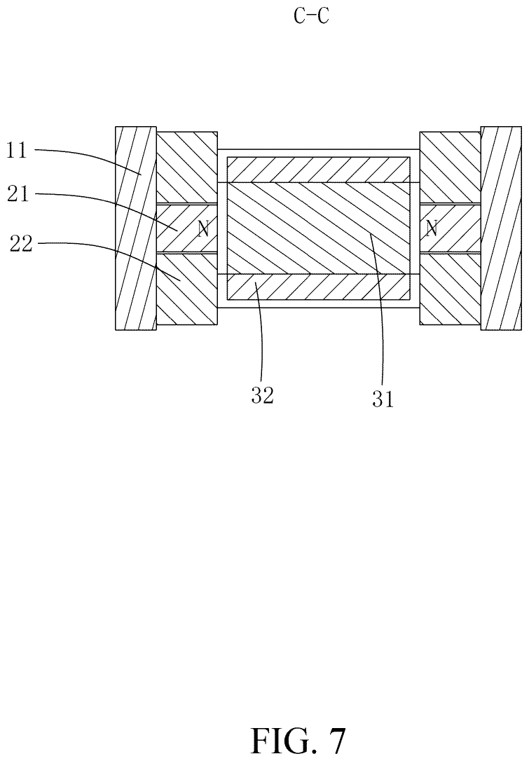

In some embodiments, referring to FIGS. 6 and 7, the two lateral casings 11 of the button motor 100 are both in a form of flat plates and are not magnetic conductive structures. In this case, the two iron cores 21 are magnetized, and the magnetic poles resulted from the magnetization of the two iron cores are shown in FIG. 7. In this way, the housing 1 can be free of bending, thereby facilitating the production of the housing 1.

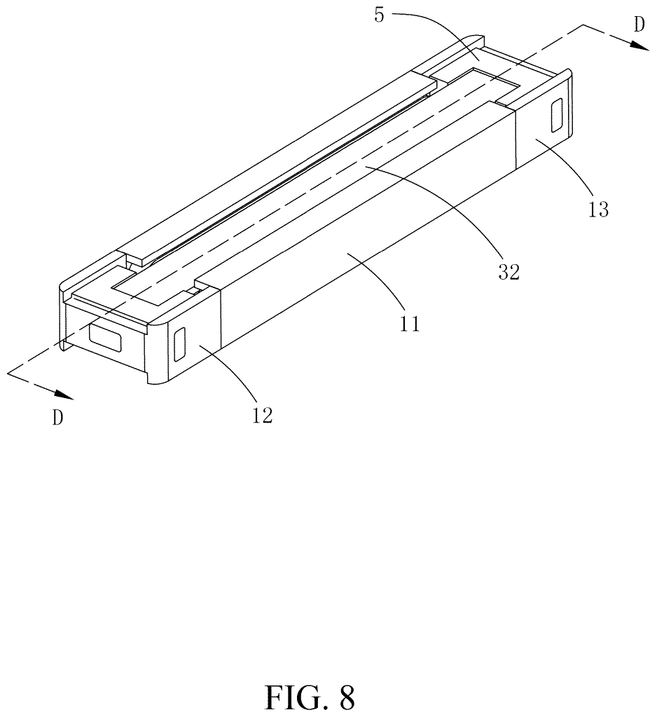

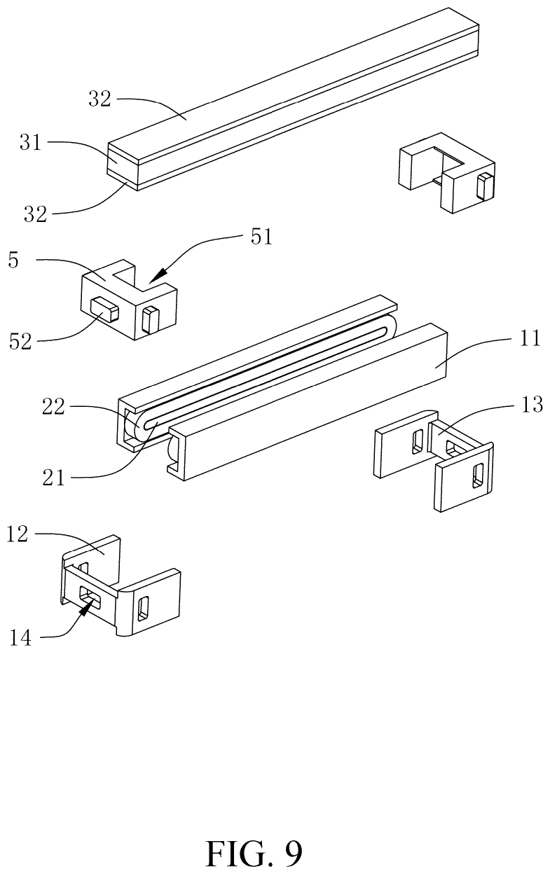

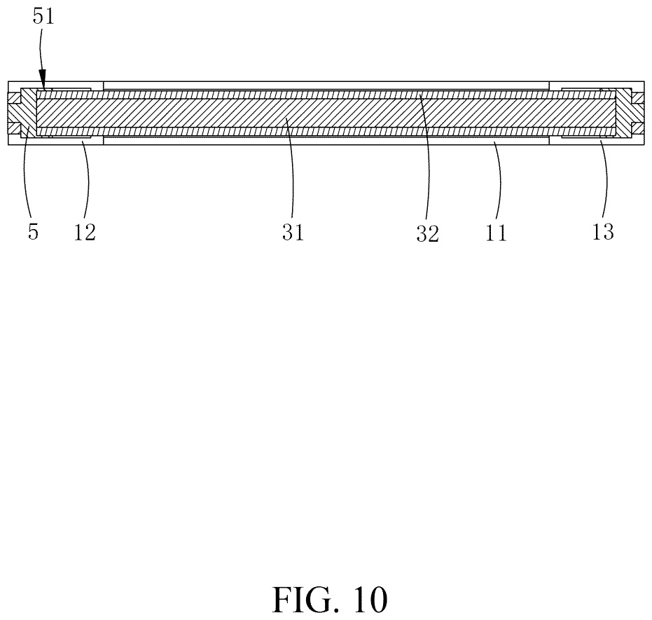

In some embodiments, referring to FIGS. 8 to 10, the button motor 100 has no connectors 6. In other words, the two non-metallic elastic components 5 are fixed and connected to the vibrator 3, and are configured to elastically suspend the vibrator 3 inside the housing 1.

The two non-metallic elastic components 5 are integrally formed with the vibrator 3. In other words, the two non-metallic elastic components 5 may be integrally formed with the vibrator 3 by injection molding, using base coating of silicone. Specifically, the two non-metallic elastic components 5 are integrally formed with the magnet 31 and the pole cores 32 of the vibrator 3 by injection molding. Alternatively, depending on actual needs, the two non-metallic elastic components 5 may be fixed and connected to the magnet 31 and the pole cores 32 of the vibrator 3 by bonding (using adhesive).

Ends of the magnet 31 and the pole cores 32 are directly fixed in the recesses 51 defined on the two non-metallic elastic components 5, respectively.

The button motor 100 without the connectors 6 can reduce the use of components and further increase the dimensions of magnetic circuits.

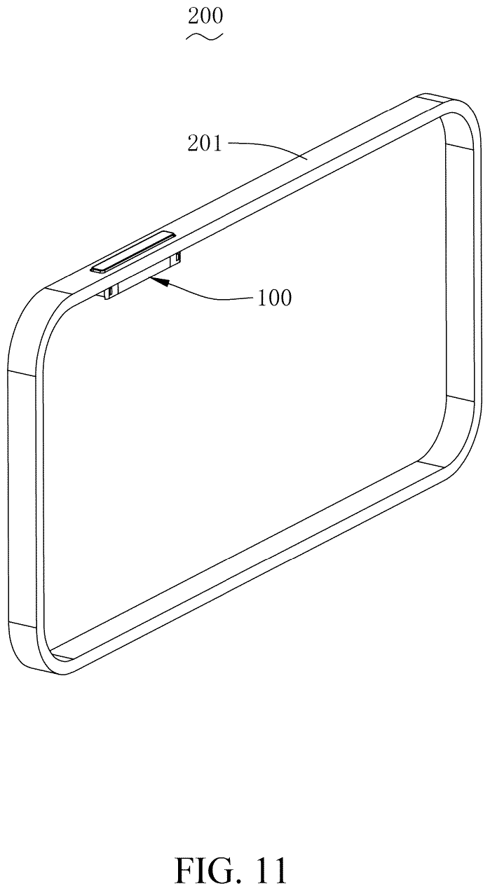

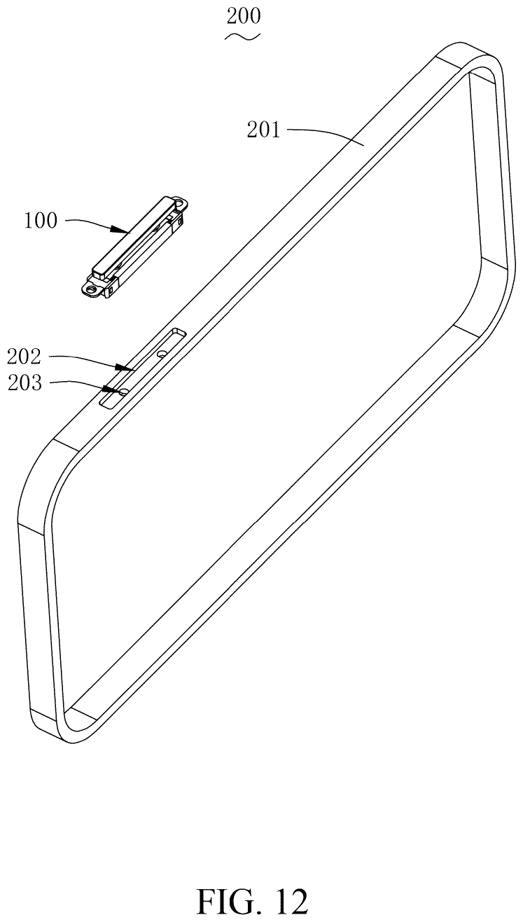

Some embodiments of the present disclosure provide an electronic device 200, referring to FIGS. 11 and 12, the electronic device includes the button motor 100 as illustrated above and a frame 201 configured to accommodate the button motor 100. A recessed accommodating slot 202 is defined on an outer surface of the frame 201, and through holes 203 are defined on a bottom of the accommodating slot 202. The housing 1 is fixed to an inner surface of the frame 201 opposite to the outer surface, and a portion of structures of the button device 4 is accommodated in the accommodating slot 202, passes through the through holes 203, and is fixed to the vibrator 3.

A portion of the main body 41 of the button device 4 is accommodated in the accommodating slot 202, and each of the first connector 6 and the second connector 6 of the button device 4 passes through a respective through hole 203 defined on the bottom of the accommodating slot 202 and is fixed to a pole core 32.

When the first connector 6 and the second connector 6 are provided with guide components 44, the guide components 44 are fixed in the through holes 203.

The electronic device 200 may be a mobile phone, an augmented reality (AR) device, a headphone, a hand controller, a steering wheel, a tablet computer, or a device that requires operation of the button device 4.

Due to the fact that the electronic device 200 includes the button motor 100 illustrated above, the technical effects of the button motor 100 as illustrated above also can be achieved by the electronic device, and will not be repeated here.

The above are only embodiments of the present disclosure. It should be pointed out that those skilled in the art can make improvements without departing from the inventive concept of the present disclosure, and these improvements all fall within the scope of protection of the present disclosure.

What is claimed is:

1. A button motor, comprising:
a hollow housing;
a stator fixed at both ends of the housing;
a vibrator having two ends elastically supported on the both ends of the housing, respectively; and
a button device fixed to the vibrator;
wherein the vibrator is spaced apart from the stator and is moveable in a first direction relative to the stator;
wherein the vibrator comprises a magnet and pole cores fixed on both sides of the magnet in the first direction, respectively, and the button device is fixed on a side of one pole core of the pole cores away from the magnet;
wherein the stator comprises two iron cores respectively fixed on both sides of the housing and coils respectively wound on the two iron cores;
wherein the button motor further comprises two non-metallic elastic components fixed at the both ends of the housing, respectively, and the two non-metallic elastic components are deformable in the first direction; and
wherein the two non-metallic elastic components are fixedly connected to the vibrator, respectively, and are configured to elastically suspend the vibrator inside the housing.

2. The button motor according to claim 1, further comprising connectors integrally formed with the two non-metallic elastic components, respectively, wherein each connector of the connectors is formed on a side of a respective non-metallic elastic component of the two non-metallic elastic components facing the vibrator and is fixedly connected to the vibrator.

3. The button motor according to claim 2, wherein the connectors are respectively fixed to the pole cores and spaced apart from the magnet.

4. The button motor according to claim 2, wherein a respective recess extending away from the magnet is defined on a surface of each non-metallic elastic component of the two non-metallic elastic components facing the magnet, and the connectors are formed in recesses, respectively.

5. The button motor according to claim 1, wherein the two non-metallic elastic components are integrally formed with the vibrator.

6. The button motor according to claim 1, wherein the two non-metallic elastic components are made of silicone or rubber.

7. The button motor according to claim 1, wherein each non-metallic elastic component of the two non-metallic elastic components has a respective fixing portion extending from a respective outer periphery of each non-metallic elastic component, fixing holes passing through the housing are defined on the housing, and each fixing hole of the fixing holes is configured for the respective fixing portion to extend through.

8. The button motor according to claim 1, wherein the housing comprises two lateral casings opposite to each other and parallel to a long-axis direction of the housing, a first end cap, and a second end cap, and each of the first end cap and the second end cap is connected to the two lateral casings at respective ends of the two lateral casings; and
wherein the two iron cores are respectively fixed on sides of the two lateral casings facing each other, and the two non-metallic elastic components are respectively fixed to the first end cap and the second end cap.

9. The button motor according to claim 8, wherein the two lateral casings are both in a form of flat plates; or
wherein the two lateral casings are both magnetic conductive structures and each have a U shape.

10. The button motor according to claim 1, wherein the button device comprises a main body spaced apart from and opposite to the housing and a first connection portion and a second connection portion extending from a surface of the main body facing the pole cores, and each of the first connection portion and the second connection portion extends into the housing and is fixed to a pole core.

11. An electronic device, comprising the button motor according to claim 1 and a frame configured to accommodate the button motor, wherein a recessed accommodating slot is defined on an outer surface of the frame, and through holes are defined on a bottom of the accommodating slot; and
wherein the housing is fixed to an inner surface of the frame opposite to the outer surface, and a portion of structures of the button device is accommodated in the accommodating slot, passes through the through holes, and is fixed to the vibrator.
